(19) United States
(12) Patent Application Publication
(10) Pub. No.: US 2016/0258840 A1
(43) Pub. Date: Sep. 8, 2016

(54) Device for Measuring Optical Properties

(71) Applicant: Tyco Electronics Japan G.K., Kanagawa (JP)

(72) Inventor: Shigeru Kobayashi, Kanagawa (JP)

(73) Assignee: Tyco Electronics Japan G.K., Kanagawa (JP)

(21) Appl. No.: 15/156,553

(22) Filed: May 17, 2016

Related U.S. Application Data
(63) Continuation of application No. PCT/JP2014/079232, filed on Nov. 4, 2014.

(30) Foreign Application Priority Data
Nov. 19, 2013 (JP) 2013-238489

(51) Int. Cl. G01M 11/00

(52) U.S. Cl. CPC G01M 11/33; G01J 1/42

(57) ABSTRACT

A device for measuring optical properties is disclosed. The measuring device comprises an optical fiber provided with a first end and an opposite second end, and a light source emitting measurement light incident on the first end. The measurement light is of a numerical aperture such that an insertion loss corresponds to an insertion loss according to a steady mode excitation of the optical fiber.

### CROSS-REFERENCE TO RELATED APPLICATIONS

This application is a continuation of PCT International Application No. PCT/JP2014/079232, filed Nov. 4, 2014 which claims priority under 35 U.S.C. §119 to Japanese Patent Application No. 2013-238489, filed Nov. 19, 2013.

### FIELD OF THE INVENTION

The present invention relates to a device suitable for measuring optical properties, and more particularly, to a device measuring optical properties of an optical fiber in an optical connector.

### BACKGROUND

Known optical fibers are classified into multi-mode optical fibers allowing passage of a plurality of modes and single-mode optical fibers allowing passage of a single mode. The multi-mode optical fibers are classified into step index (SI)-type optical fibers where a refractive index distribution within a core is uniform and graded index (GI)-type optical fibers where a refractive index distribution within a core gradually varies. The SI-type optical fibers are widely used in industrial and automobile fields.

Known methods exist for testing insertion losses of multi-mode optical fibers, as disclosed in JP 2007-46973A. Insertion losses of an optical connector including such an optical fiber may be similarly tested. Loss measurement is generally performed by causing measurement light to be incident on an optical fiber connected to an optical connector. However, even if measurement is performed in compliance with the known method, different results may occur in respective measurements because states of optical distributions are subject to various factors.

In order to make the optical distribution state within the optical fiber stable, reproducibility of the measurement result can be obtained by adopting a steady mode excitation at a measurement time. In order to realize the reproducibility, however, a sufficiently long optical fiber is still required. As one example, a length of 2 km or more is required in a case of a plastic clad multi-mode optical fiber. Since optical fibers available in the market are in the order of several hundred meters at longest, it is thus difficult to accurately perform loss measurements on available optical fibers according to the known testing methods.

### SUMMARY

An object of the invention, among others, is to provide a device for measuring optical properties, which can obtain a measurement result of an insertion loss with excellent reproducibility without requiring a long optical fiber. The disclosed measuring device comprises an optical fiber provided with a first end and an opposite second end, and a light source emitting measurement light incident on the first end. The measurement light is of a numerical aperture such that an insertion loss corresponds to an insertion loss according to a steady mode excitation of the optical fiber.

### BRIEF DESCRIPTION OF THE DRAWINGS

The invention will now be described by way of example with reference to the accompanying figures, of which:

FIG. 1(a) is a schematic view of a measuring device according to the invention;

FIG. 1(b) is a schematic view of an insertion loss measurement procedure using the measuring device of FIG. 1(a);

FIG. 1(c) is a schematic view of an insertion loss measurement procedure using the measuring device of FIG. 1(a);

FIG. 2(a) is a schematic view of a measuring device according to another embodiment of the invention;

FIG. 2(b) is a schematic view of a measuring device according to another embodiment of the invention;

FIG. 3 is a graph depicting an experimental result of the measuring device of FIG. 1(a);

FIG. 4 is a table depicting insertion losses of exemplary optical fibers;

FIG. 5(a) is a schematic view of the measuring device of FIG. 1(a) in a first exemplary configuration of FIG. 4;

FIG. 5(b) is a schematic view of the measuring device of FIG. 1(a) in a second exemplary configuration of FIG. 4; and

FIG. 5(c) is a schematic view of the measuring device of FIG. 1(a) in a third exemplary configuration of FIG. 4.

### DETAILED DESCRIPTION OF THE EMBODIMENT(S)

The invention is explained in greater detail below with reference to embodiments of a device for measuring optical properties. This invention may, however, be embodied in many different forms and should not be construed as limited to the embodiments set forth herein; rather, these embodiments are provided so that this disclosure will be thorough and complete and still fully convey the scope of the invention to those skilled in the art.

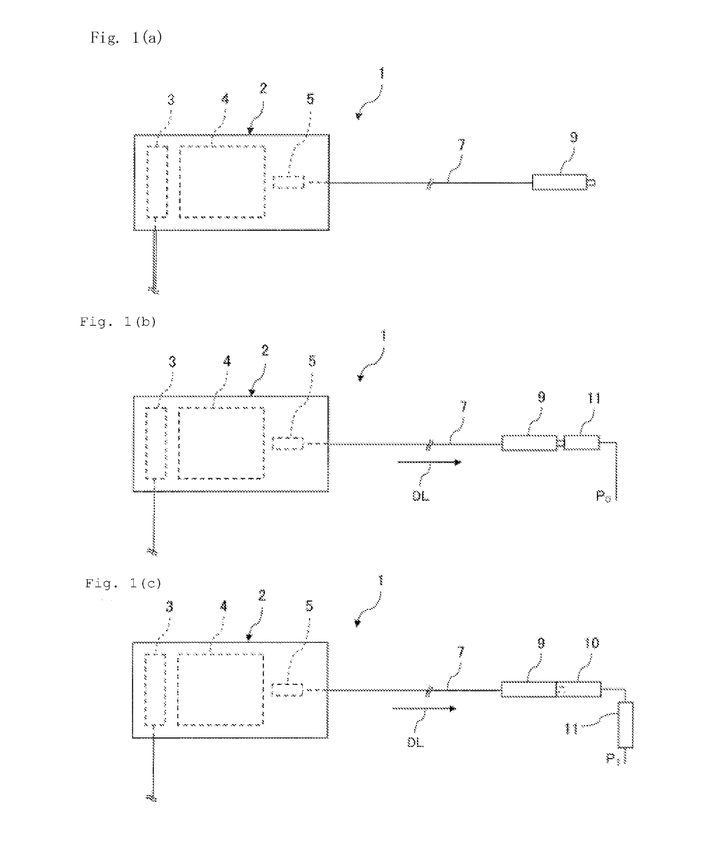

A measuring device 1 for measuring optical properties of an optical fiber part is shown generally in FIG. 1. The measuring device 1 includes a light source module 2, an optical fiber 7, and a launch connector 9. The major components of the invention will now be described in greater detail.

The light source module 2, as shown in FIG. 1(a), is composed of a light source 3, an optical system 4 guiding measurement light DL emitted from the light source 3 efficiently, and, for example, a ferrule 5. The light source 3 may be a laser diode or a light-emitting diode serving as a stabilized light source, but the present invention is not limited to these diodes and can also use a white light source using a halogen lump or the like. The optical system 4 may be composed of a single optical lens or a plurality of optical lenses.

The optical fiber 7 may be any form of optical fiber 7 known to those with ordinary skill in the art. One end side of the optical fiber 7 is connected to the light source module 2 at the ferrule 5, and the launch connector 9 is connected with an opposite end side of the optical fiber 7.

The launch connector 9 may be any connector known to those with ordinary skill in the art permitting connection of the optical fiber 7 and measuring device 1 to exterior elements.

The measuring device 1 may also include an optical connector 10 and a light power meter 11, as shown in FIG. 1(b) and FIG. 1(c). The optical connector 10 may be any form of connector known to those with ordinary skill in the art capable of connecting to the launch connector 9. The light power meter 11 may be a thermal conversion-type or a photoelectric conversion-type, but any known light power meter 11 can be used.

The use and operation of the measuring device 1 will now be described in greater detail.

The measuring device 1 performs irradiation of measurement light DL, shown in FIG. 1(c), from the light source module 2 toward an optical connector 10 in a state where the optical connector 10 constituting a measurement target has been attached to the launch connector 9. The intensity P₁ of the measurement light DL passing through the optical connector 10 is measured by using the light power meter 11. Additionally, as shown in FIG. 1(b), intensity P₀ of measurement light DL emitted from the launch connector 9 is preliminarily measured by the light power meter 11 in a state in which the measuring device 1 is not attached with the optical connector 10. A measurement of an insertion loss of the optical connector 10 can be obtained from the measured intensities P₁ and P₀.

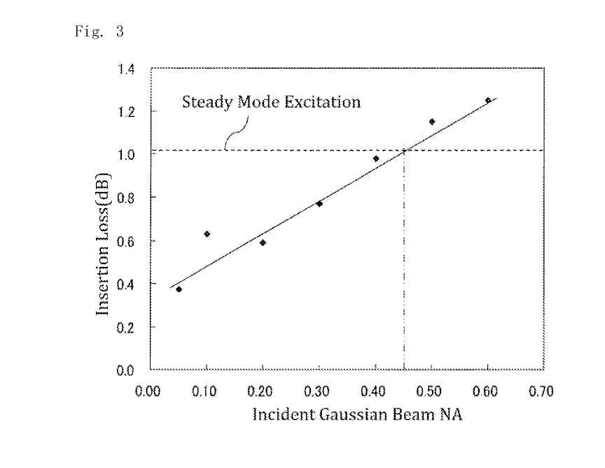

An insertion loss L_{β} was experimentally measured using measurement light DL emitted from the launch connector 9 of the measuring device 1. As the optical fiber 7, a hard polymer clad fiber having a length of 1 m, a core diameter/clad diameter=200 μm/230 μm, and a numerical aperture (NA)=0.37 was used. Further, lights where the NA has been fluctuated in a range of 0.05 to 0.60 were caused to be incident on the optical fiber 7 from the light source 3. As the incident light, a Gaussian beam can be used. For comparison, a steady mode excitation was created using an optical fiber with a length of 2 km having the same specification as the above and an insertion loss L_{α} of the optical fiber 7 was measured. A result of the measurement is shown in Table 1, and a result obtained by analyzing the result shown in Table 1 utilizing linear approximation is further shown in FIG. 3.

TABLE 1

| Incident Gaussian | Insertion Loss |
|---|---|
| Beam NA | (dB) |
| 0.05 | 0.37 |
| 0.1 | 0.63 |
| 0.2 | 0.59 |
| 0.3 | 0.77 |
| 0.4 | 0.98 |
| 0.5 | 1.15 |
| 0.6 | 1.25 |
| Steady Mode Excitation | 1.04 |

As shown in Table 1 and FIG. 3, it is understood that the insertion loss L_{β} to the NA of the incident light is substantially linear. Further, comparing the result of the insertion loss L_{β} and the insertion loss L_{α} (=1.04) according to the steady mode excitation with each other, the insertion loss L_{β} can be caused to coincide with or come close to the insertion loss L_{α} according to the steady mode excitation by setting the NA of the incident light to 0.45 or so. That is, by adjusting the NA of the incident light, a state of light distribution equivalent to that of light according to the steady mode excitation can be reproduced.

In the case of this experimental example, a satisfactory result can be obtained by causing light of NA (0.45) of 1.2 times NA of 0.37 of the optical fiber to be incident on the optical fiber by the measuring device 1. The NA of light can be determined considering variations to the insertion loss. For example, when a margin based upon the variation is set to ±15%, a connector loss can be measured by using light of NA of 0.95 to 1.5 times the NA of the optical fiber.

Setting of the measuring device 1 will be explained based upon the above experimental result.

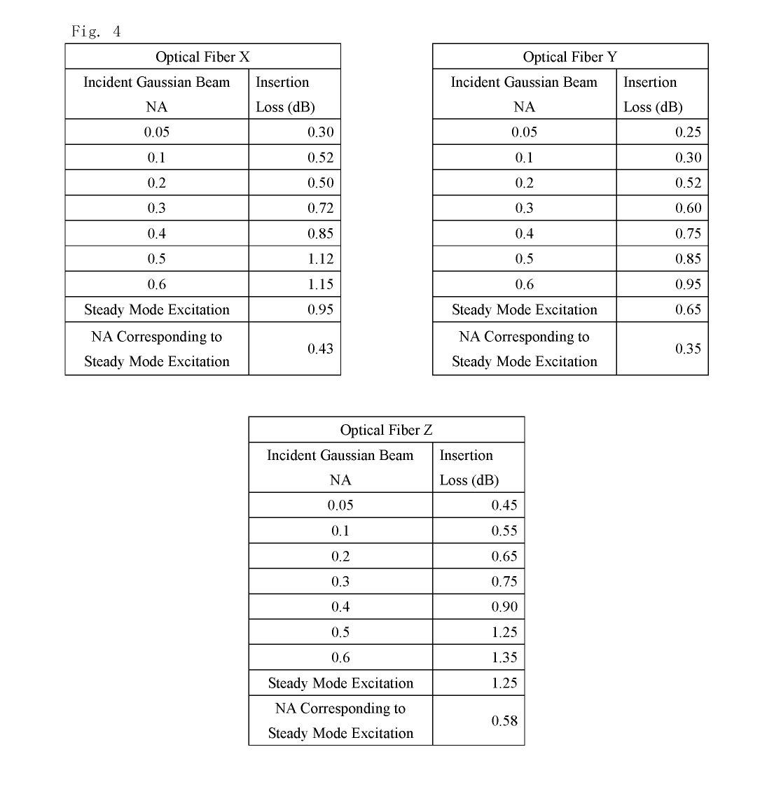

First, regarding a given optical fiber 7 to be applied to the measuring device 1, an insertion loss (L_{α}) according to a steady mode excitation is acquired. When the steady mode excitation is known, a value thereof may be used, or a test for newly acquiring an insertion loss may be performed. Regarding the optical fiber 7, many kinds thereof are present and are standardized, so that the insertion losses L_{α} according to the steady mode excitation are acquired in advance corresponding to the kinds of the optical fibers 7 applied to the measuring device 1. When optical fibers 7 belonging to standards such as [optical fiber X], [optical fiber Y], [optical fiber Z] . . . are applied to the measuring device 1, as shown in FIG. 4, the insertion losses L_{α} according to the steady mode excitation are acquired corresponding to the respective kinds (X, Y, Y . . . ) of the optical fibers 7 to be applied to the measuring device 1.

Next, insertion losses are measured by using the measuring device 1 including the optical fiber 7 and the launch connector 9. The measurement is performed to each of the kinds of the optical fibers 7 while varying the NA of lights incident on the optical fibers 7. Thus, as shown in FIG. 4, measurement data L_{β} where the NA of light and the insertion loss correspond to each other can be obtained for each of the kinds of the optical fibers 7.

By collating the insertion loss L_{α} with the measurement data L_{β} of the insertion loss, the NA of the incident light which can reproduce a state of a light distribution equivalent to that of light according to the steady mode excitation in the measuring device 1 is specified. The examples of FIG. 4 show that by adopting NA of 0.43 in the optical fiber X, NA of 0.35 in the optical fiber Y, and NA of 0.58 in the optical fiber Z, states of light distributions equivalent to those of lights according to the steady mode excitation can be reproduced in the measuring device 1 when the optical fibers 7 of corresponding kinds are used. NA allowing reproduction of a state of light distribution equivalent to that of light according to the steady mode excitation is hereinafter referred to as “reproduction NA”.

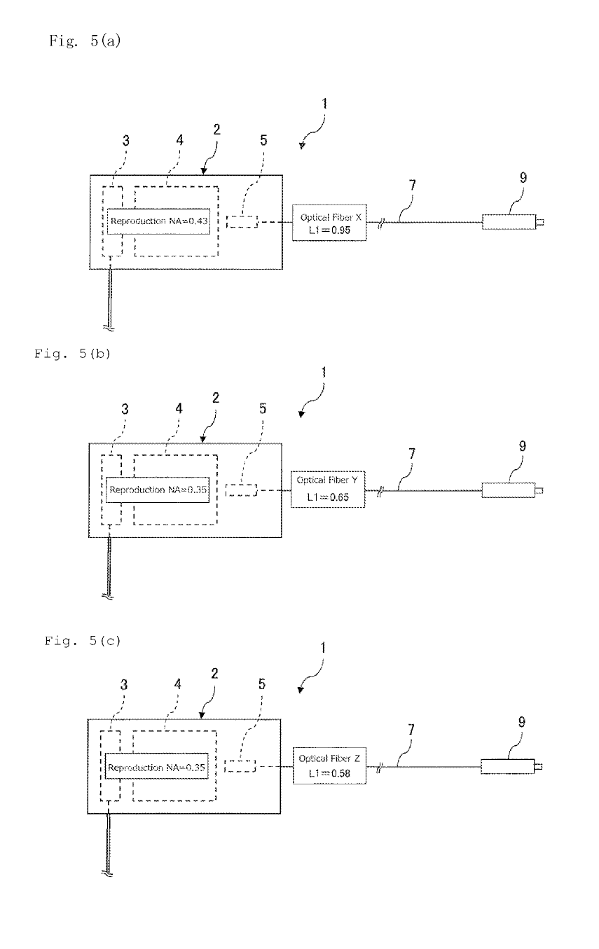

After the reproduction NA has been obtained, the incident light on the measuring device 1 is adjusted so as to achieve the reproduction NA. For example, as shown in FIG. 5, in the measuring device 1 using the optical fiber X as the optical fiber 7, the NA of incident light is set at 0.43, and similarly, the NA of incident light is set at 0.36 in the measuring device 1 using the optical fiber Y and the NA of incident light is set at 0.58 in the measuring device 1 using the optical fiber X.

The NA is given from the following equation (1) when the maximum angle to an optical axis of a light beam incident on an objective lens (the optical system 4 in this embodiment) from an object (the light source 3 in this embodiment) is represented by θ and a refractive index of a medium between the object and the objective lens is represented by n (air, n=1). Therefore, in order to adjust the NA of the incident light, adjustments of the light source 3 and the optical system 4 can be performed based upon the equation (1).

NA=n·sin θ (1)

The measuring device 1 is configured such that light of NA which can obtain an insertion loss L_{β} corresponding to the insertion loss L_{α} of the optical fiber 7 according to the steady mode excitation is caused to be incident on the optical fiber 7, and according to this configuration, the measuring device 1 can reproduce a state of a light distribution equivalent to that of light according to the steady mode excitation. Therefore, according to the measuring device 1 according to this embodiment, a insertion loss measurement can be obtained with excellent reproducibility without using a long optical fiber.

A measurement target is not limited to the optical connector 10, and various parts may be used to measure optical properties of the optical fiber 7 including, for example, a splitter, a combiner, a multiplexer/demultiplexer, and an SI-type embedded waveguide. Fields where these optical parts are used may also vary as the present invention can be applied to various fields such as an industrial field, an automobile field, an aerospace field, and the like.

Further, though the insertion loss has been adopted as a measurement target of the optical properties in the above embodiment, the present invention is not limited to this insertion loss. The present invention is characterized in that even if an optical fiber with a short length is used, a state of an optical distribution equivalent to that of light according to the steady mode excitation can be reproduced, and other optical properties which can be measured utilizing this characteristic, for example, a return loss or the like, can be measured.

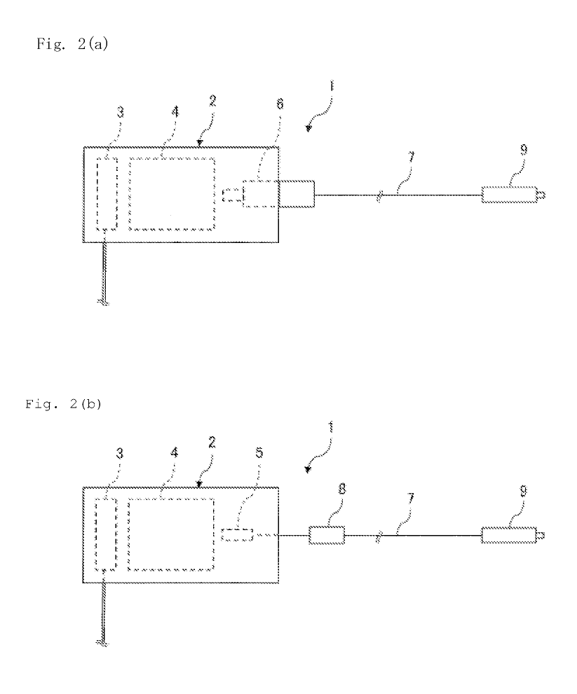

In another embodiment, shown in FIG. 2(a), instead of the fixed ferrule 5 shown in FIG. 1, an attachable/detachable plug 6 to/from the light source module 2 can be used. The plug 6 has the other end connected with the launch connector 9. Thereby, measurement can be performed by connecting a different optical fiber 7 to the light source module 2.

Further, as shown in the embodiment of FIG. 2(b), an exciter 8 may be provided in the middle of the optical fiber 7. Since the state of light in the optical fiber 7 can be trimmed to a desired distribution profile by using the exciter 8, a measurement result can be obtained more stably. Further, in addition to the exciter 8, a mode filter for removing light unnecessary for measurement can also be provided in the middle of the optical fiber 7.

Advantageously, according to the measuring device 1 of the present invention, since a distribution state of light can measure an insertion loss L_{β} of an optical fiber equivalent to that of a steady mode excitation, optical properties or an insertion loss measurement can be obtained with excellent reproducibility without using a long optical fiber.

What is claimed is:

1. A device for measuring optical properties, comprising:
an optical fiber provided with a first end and an opposite second end; and
a light source emitting measurement light incident on the first end, the measurement light of a numerical aperture NA_{β} such that an insertion loss L_{β} corresponds to an insertion loss L_{α} according to a steady mode excitation of the optical fiber.

2. The device for measuring optical properties of claim 1, wherein the optical fiber emits the measurement light at the second end.

3. The device for measuring optical properties of claim 1, wherein the numerical aperture NA_{β} is included in a range of numerical apertures for which the insertion loss L_{β} is coincident with the insertion loss L_{α}.

4. The device for measuring optical properties of claim 1, wherein the numerical aperture NA_{β} is included in a range of numerical apertures for which the insertion loss L_{β} is coincident with a predetermined margin added to the insertion loss L_{α}.

5. The device for measuring optical properties of claim 1, wherein the optical fiber is configured such that when the measurement light of the numerical aperture NA_{β} is incident on the optical fiber, a distribution state of light is equivalent to a distribution state of light according to a steady mode excitation.

6. The device for measuring optical properties of claim 1, further comprising an optical system having at least one optical lens.

7. The device for measuring optical properties of claim 6, wherein the optical system is disposed between the light source and the optical fiber.

8. The device for measuring optical properties of claim 7, further comprising a launch connector disposed on the second end of the optical fiber.

9. The device for measuring optical properties of claim 8, wherein the launch connector is connected to a light power meter measuring the intensity of light passing through the launch connector.

10. The device for measuring optical properties of claim 8, wherein the launch connector is connected to an optical connector.

11. The device for measuring optical properties of claim 10, wherein the optical connector is connected to a light power meter measuring the intensity of light passing through the optical connector.

12. The device for measuring optical properties of claim 8, further comprising a ferrule attached to the first end of the optical fiber.

13. The device for measuring optical properties of claim 12, further comprising an exciter disposed on the optical fiber between the ferrule and the launch connector.

14. The device for measuring optical properties of claim 8, further comprising a plug attached to the first end of the optical fiber.

15. A method for measuring optical properties, comprising:
determining a steady mode excitation insertion loss L_{α} of an optical fiber;
measuring an insertion loss L_{β} of the optical fiber for a range of numerical apertures NA of incident light on the optical fiber;
calculating a numerical aperture NA_{β} such that the insertion loss L_{β} corresponds to the steady mode excitation insertion loss L_{α}.

16. The method of claim 15, wherein the measuring step is accomplished by a measuring device including a light source, the optical fiber, and a light power meter measuring the intensity of light emitted by the optical fiber.

17. The method of claim 15, wherein the numerical aperture NA_{β} is included in a range of numerical apertures for which the insertion loss L_{β} is coincident with a predetermined margin added to the insertion loss L_{α}.

18. The method of claim 15, wherein the optical fiber is configured such that when the measurement light of the numerical aperture NA_{β} is incident on the optical fiber, a distribution state of light is equivalent to a distribution state of light according to the steady mode excitation.
